(19) United States
(12) Patent Application Publication
(10) Pub. No.: US 2013/0317751 A1
(43) Pub. Date: Nov. 28, 2013

(54) SYSTEM AND METHOD FOR PERFORMING GEOCHRONOLOGY

(71) Applicants: Sebastien L. Dreyfus, Houston, TX (US); Robert J. Pottorf, Houston, TX (US)

(72) Inventors: Sebastien L. Dreyfus, Houston, TX (US); Robert J. Pottorf, Houston, TX (US)

(21) Appl. No.: 13/994,597

(22) PCT Filed: Nov. 2, 2011
(86) PCT No.: PCT/US11/58982

§ 371 Date: Jun. 14, 2013

Related U.S. Application Data
(60) Provisional application No. 61/432,660, filed on Jan. 14, 2011.

(51) Int. Cl. G01V 9/00

(52) U.S. Cl. CPC G01V 9/00
USPC 702/11; 250/282

(57) ABSTRACT

Systems and methods for determining geologic age are provided. A method includes separating a sample into species of interest; supplying the species of interest to a mass spectrometer; generating an intensity-versus-time data set for two or more elemental masses, identifying a set of intensity peaks having members from each of at least two of the intensity-versus-time data sets; and determining the geologic age of the sample using ratios of the members of the set of intensity peaks. A system includes a species generator for receiving a sample and generating species of interest; a mass spectrometer for receiving the species of interest and generating an intensity-versus-time data set for each of two or more elemental masses; and a processor configured to identify a set of intensity peaks, and to determine the geologic age of the sample using ratios of the members of the set of intensity peaks.

### CROSS-REFERENCE TO RELATED APPLICATION

This application claims the benefit of U.S. Provisional Patent Application 61/432,660 filed Jan. 14, 2011 entitled SYSTEM AND METHOD FOR PERFORMING GEOCHRONOLOGY, the entirety of which is incorporated by reference herein.

### FIELD OF THE INVENTION

Embodiments of the present disclosure relate generally to the field of geochemistry. More particularly, the present disclosure relates to systems and methods for determining the age of a geologic material.

### BACKGROUND

This section is intended to introduce various aspects of the art, which may be associated with exemplary embodiments of the present disclosure. This discussion is believed to assist in providing a framework to facilitate a better understanding of particular aspects of the present invention. Accordingly, it should be understood that this section should be read in this light, and not necessarily as admissions of prior art.

Conventional techniques for dating of geologic materials, such as rocks, minerals, organic matter, oils or oil fractions, generally involve (i) isolating the material of interest; (ii) performing a series of wet chemistry steps in which the parent and daughter elements are separated, for example distillation and anion-exchange chromatography; and (iii) performing isotopic ratio measurements using mass spectrometry. The process is generally complex, time consuming, costly, and non-specific with respect to where the parent/daughter elements are bound in the sample. For example, results published to date on rhenium-osmium (Re—Os) isotopic analysis of oils and oil fractions appear to report only the bulk isotopic composition of petroleum fluids, with no distinction between isotopic signatures for organic and inorganic species. Elements within organic species found in oils and oil fractions (e.g., Re, Os, U, Th, Pb, Rb, Sr) are related directly to the oil source rock and can therefore be used as radiometric chronometers for petroleum generation/expulsion dating. These metal-bearing organic species are easily contaminated by inorganic compounds within inorganic fluids and solids mixed with the oils, resulting in erroneous ages. Without deconvolution of the different species, the geochronologic results may be ambiguous or in error.

### SUMMARY

Accordingly, the present disclosure provides a system and method for estimating/determining the geologic age of a sample without the use of conventional wet-chemistry preparation techniques. By eliminating the need for wet-chemistry techniques, the overall expense, inconvenience, delay, and/or potential inaccuracies of sample preparation may be reduced.

According to the present disclosure, then, a method for determining the geologic age of a sample of a naturally-occurring substance is provided. The method comprises separating the sample into one or more species of interest; supplying the one or more species of interest to a mass spectrometer; generating an intensity-versus-time data set for each of two or more elemental masses; identifying a set of intensity peaks having members from each of at least two of the intensity-versus-time data sets, the members corresponding to a single species of interest; and determining the geologic age of the sample using ratios of the members of the set of intensity peaks. The mass spectrometer is configured for two or more elemental masses selected from the group consisting of radioactive-parent mass, radiogenic-daughter mass, and stable-daughter mass. Each of the selected two or more elemental masses are included in at least one of the one or more species of interest. Each of the intensity-versus-time data sets includes one or more intensity peaks. Each of the intensity peaks corresponding to one of the species of interest.

Also according to the present disclosure, a computer readable medium comprising non-transitory instructions is provided. The instructions correspond to separating a sample into one or more species of interest; supplying the one or more species of interest to a mass spectrometer; generating an intensity-versus-time data set for each of two or more elemental masses; identifying a set of intensity peaks having members from each of at least two of the intensity-versus-time data sets, the members corresponding to a single species of the one or more species of interest; and determining a geologic age of the sample using ratios of the members of the set of intensity peaks. The mass spectrometer is configured for two or more elemental masses selected from the group consisting of radioactive-parent mass, radiogenic-daughter mass, and stable-daughter mass. Each of the selected two or more elemental masses are included in at least one of the one or more species of interest. Each of the intensity-versus-time data sets includes one or more intensity peaks. Each of the intensity peaks corresponding to one of the species of interest.

Still further according to the present disclosure, a system for determining the geologic age of a sample of a substance is provided. The system includes a species generator, a mass spectrometer, and a processor. The species generator is configured to receive the sample and to generate one or more species of interest. The mass spectrometer is configured to receive the one or more species of interest and to generate an intensity-versus-time data set for each of two or more predetermined elemental masses. Each of the intensity-versus-time data sets includes one or more intensity peaks and each of the intensity peaks corresponding to one of the species of interest. The processor is configured to identify a set of intensity peaks having members from each of at least two of the intensity-versus-time data sets, the members corresponding to a single species of the one or more species of interest; and determine the geologic age of the sample using ratios of the members of the set of intensity peaks.

These and other features and advantages of the present disclosure will be readily apparent upon consideration of the following description in conjunction with the accompanying drawings.

### BRIEF DESCRIPTION OF THE DRAWINGS

FIG. 1 is a simplified block diagram of a system in accordance with an embodiment of the present invention;

FIG. 2 is a flow diagram of a method in accordance with an embodiment of the present invention;

FIG. 3 is an exemplary plot of intensity-versus-time data sets in accordance with an embodiment of the present invention; and

FIG. 4 is an exemplary isochronic plot in accordance with an embodiment of the present invention.

### DETAILED DESCRIPTION DEFINITIONS

Various terms as used herein are defined below. To the extent a term used in a claim is not defined below, it should be given the definition persons in the pertinent art have given that term in the context in which it is used.

As used herein, “a” or “an” entity refers to one or more of that entity. As such, the terms “a” (or “an”), “one or more”, and “at least one” can be used interchangeably herein unless a limit is specifically stated.

As used herein, the terms “comprising,” “comprises,” “comprise,” and “comprised” are open- ended transition terms used to transition from a subject recited before the term to one or more elements recited after the term, where the element or elements listed after the transition term are not necessarily the only elements that make up the subject.

As used herein, the terms “containing,” “contains,” and “contain” have the same open-ended meaning as “comprising,” “comprises,” and “comprise.”

As used herein, the terms “having,” “has,” and “have” have the same open-ended meaning as “comprising,” “comprises,” and “comprise.”

As used herein, the terms “including,” “includes,” and “include” have the same open-ended meaning as “comprising,” “comprises,” and “comprise.”

As used herein the term “aqueous” means water-based.

As used herein the phrase “associated with an organic fraction” refers to an element (e.g., nickel or vanadium) that (i) is part of an organic molecule such as a porphyrin (e.g., a nickel porphyrin); or (ii) is otherwise present with, and perhaps bound to, an organic compound.

As used herein the term “isotope” refers to one of two or more atoms with the same atomic number but with different numbers of neutrons. Elements found in petroleum may be present in a variety of isotopes. As a well-known example, naturally-occurring uranium often includes at least two isotopes: U-238, which has 92 protons and 146 neutrons; and, in much lower concentrations, U-235, which again has 92 protons but only 143 neutrons.

As used herein the term “marker” means, with respect to a given sample, one or more elements, isotopes, or compounds, that usually are not naturally present in a sample of interest. Measurement of various marker concentrations in organic and inorganic fractions of a sample may help (i) to track, for example, the efficiency of sample separation and/or (ii) to determine more precisely the amounts of the fractions recovered after sample preparation. See also Standard.

As used herein the term “petroleum” includes, but is not limited to: gases, oils, tars, bitumens, asphaltenes, and/or the like. Natural petroleum also typically includes various elements such as, for example, nickel (Ni), vanadium (V), molybdenum (Mo), iron (Fe), cobalt (Co), rhenium (Re), gallium (Ga), osmium (Os), uranium (U), thorium (Th), and/or lead (Pb).

As used herein the term “aqueous fluids” includes, but is not limited to: water based fluids, solubilized (i.e., fluid-borne) rock or mineral (i.e., product of the digestion of a rock or mineral), and/or the like.

As used herein the phrase “organic fractions of petroleum” refers to groups of organic compounds that are associated with natural petroleum such as asphaltenes, NSO (nitrogen-sulfur-oxygen) fractions, and/or the like.

As used herein the term “radiogenic” refers generally to an isotope of an element that is created by radioactive decay; for example, osmium-187 is a radiogenic isotope created by radioactive decay of rhenium-187.

As used herein the term “signatures” refers to the relative abundances, concentrations and/or ratios of various elements and elemental isotopes.

As used herein the term “standard” refers to a solid or liquid having a known (and, generally, a certified) composition comprising one or more markers, typically used as an internal tracer or reference point. An organic standard might be, for example, a certified trace-element concentration of uranium, thorium, bismuth, or specific isotopes thereof, in an organic solvent such as xylene. Similarly an inorganic standard might be, for example, a similar trace-element concentration in an aqueous (i.e., water-based) solution. See also Marker.

### DETAILED DESCRIPTION

In the following section, specific embodiments of the present invention are described in connection with preferred embodiments. However, to the extent that the following description is specific to a particular embodiment or a particular use, this is intended to be for exemplary purposes only. Accordingly, the invention is not limited to the specific embodiments described below, but rather, it includes all alternatives, modifications, and equivalents falling within the scope of the appended claims.

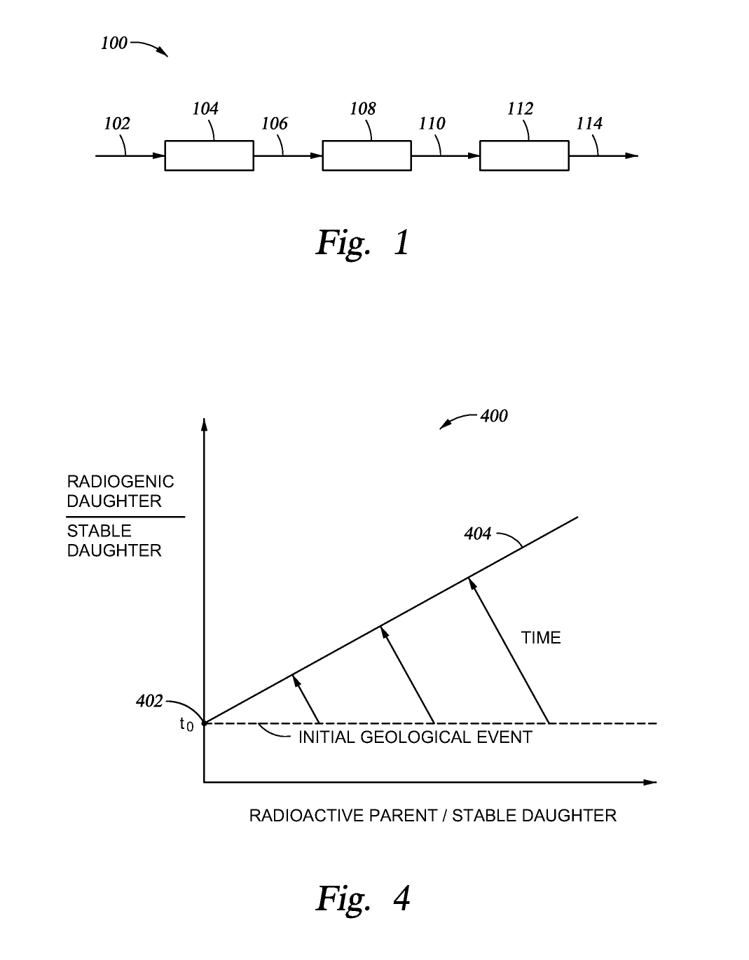

Referring to FIG. 1, a diagram illustrating a system 100 that may be implemented in connection with the present invention is shown. The system generally includes a sample 102, a species generator 104 to receive the sample 102 and generate one or more species of interest 106, and/or a mass spectrometer 108 to receive the specie(s) of interest 106 and generate one or more data sets 110.

In general the sample 102 may be substantially petroleum or a mixture of petroleum and an aqueous fluid. However the sample 102 may be any substance or mixture capable of generating a species of interest 106 (e.g., an elemental compound associated with an organic fraction such as a vanadium porphyrin, nickel porphyrin, iron porphyrin, or the like). Similarly, the sample 102 may be generated using any appropriate mechanism.

The species generator 104 generally represents any technology for receiving the sample 102 and generating there-from one or more species of interest 106. In at least one embodiment, a chromatographic column may be used to separate the sample 102 into the one or more species of interest 106. In such an embodiment the chromatographic column may be a liquid-chromatography column, such as a gel permeation chromatography column, or a gas chromatography column. However, any appropriate chromatographic column or set of columns may be implemented to meet the design criteria of a particular application. Furthermore, each chromatographic column may use any appropriate mechanism, such as polarity or molecular size, to separate the sample 102. In at least one other embodiment, one or more chromatographic materials, such as a paper based material and/or a gel based material, may be used for separating the sample into one or more species of interest 106. However, any appropriate technique may be implemented to meet the design criteria of a particular application. It may be appreciated that a species of interest 106 is generally any substance or set of substances capable of being derived from the sample 102 and of interest to an operator of the system 100.

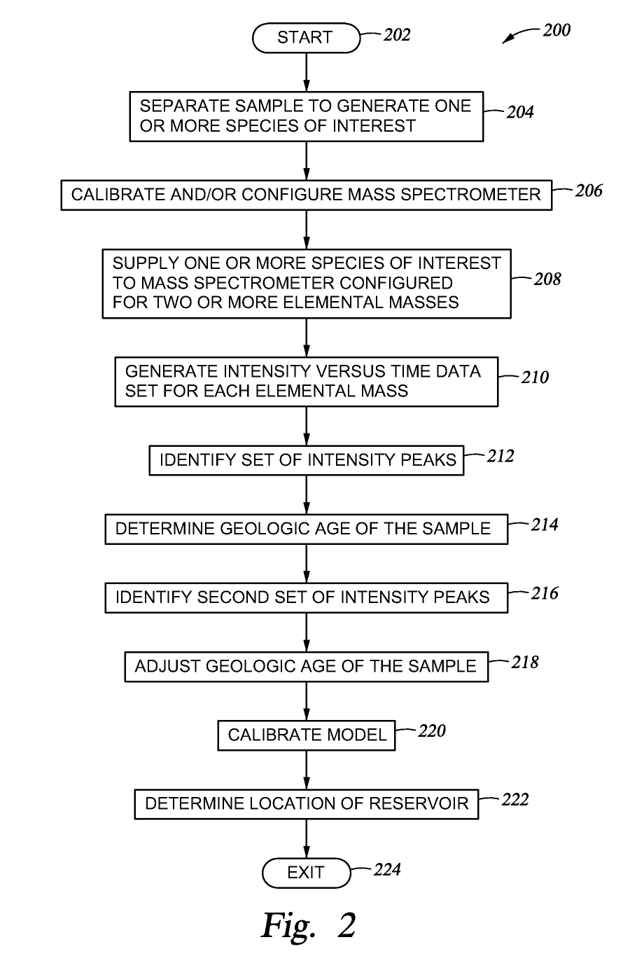

The mass spectrometer 108 may be any appropriate mass spectrometer or group of mass spectrometers, such as an inductively-coupled plasma mass spectrometer or more specifically a multi-collector inductively-coupled plasma mass spectrometer, that is capable of receiving the one or more species of interest 106 and generating a data set 110. The species of interest 106 may be supplied to (i.e., received by) the mass spectrometer 108 using any appropriate mechanism, such as laser ablation. Data sets 110 generally correspond to intensity over a duration of time. In at least one embodiment, data sets 110 may be used to determine (i.e., estimate) the geologic age of the sample 102 as discussed in connection with FIG. 2. Optionally, in at least one embodiment, a processor or other computational device 112 may be implemented to generate user output data 114 corresponding to the geologic age of the sample 102.

Referring to FIG. 2, a flow diagram of a method 200 for determining the geologic age of a sample of a naturally-occurring substance is shown. The method 200 may be advantageously implemented in connection with the system 100, described previously in connection with FIG. 1, and/or any appropriate system to meet the design criteria of a particular application. The method 200 generally includes a plurality of blocks or steps (e.g., 202, 204, 206, and the like) that may be performed serially. As will be appreciated by one of ordinary skill in the art, the order of the steps shown in FIG. 2 is exemplary and the order of one or more steps may be modified within the spirit and scope of the present invention. Additionally, the steps of the method 200 may be performed in at least one non-serial (or non-sequential) order, and one or more steps may be omitted to meet the design criteria of a particular application.

Block 202 represents an entry point into the method 200.

At block 204 a sample (e.g., 102) is separated into one or more species of interest (e.g., 106). In general the sample may be substantially petroleum or a mixture of petroleum and an aqueous fluid. However the sample may be any substance or mixture capable of generating a species of interest (e.g., an elemental compound associated with an organic fraction such as a vanadium porphyrin, nickel porphyrin, iron porphyrin, or the like). It may be appreciated that the species of interest is generally any substance capable of being derived from the sample and of interest to an operator of the method 200.

In at least one embodiment, a chromatographic column may be used to separate the sample into the one or more species of interest. In such an embodiment the chromatographic column may be a liquid-chromatography column, such as a gel permeation chromatography column, or a gas chromatography column. However, any appropriate chromatographic column or set of columns may be implemented to meet the design criteria of a particular application. Furthermore, each chromatographic column may use any appropriate mechanism, such as polarity or molecular size, to separate the sample. In at least one other embodiment, one or more chromatographic materials, such as a paper based material and/or a gel based material, may be used for separating the sample into one or more species of interest. However, any appropriate technique may be implemented to meet the design criteria of a particular application.

At block 206 a mass spectrometer (e.g., 108) may be calibrated for use in the method 200. In at least one embodiment the mass spectrometer may be optionally calibrated by adding a standard, such as an isotopic standard, to the sample or a portion of the sample. However, any appropriate calibration technique may be implemented to meet the design criteria of a particular embodiment.

Configuration of the mass spectrometer is generally performed at block 206 and generally includes configuring the mass spectrometer for two or more elemental masses, wherein each of the two or more elemental masses is included in at least one of the species of interest. For example, in at least one embodiment, the two or more elemental masses may be selected from the group consisting of radioactive-parent mass, radiogenic-daughter mass, and stable-daughter mass. In general, the term “elemental mass” refers to an isotope of an element of interest that is present in the sample.

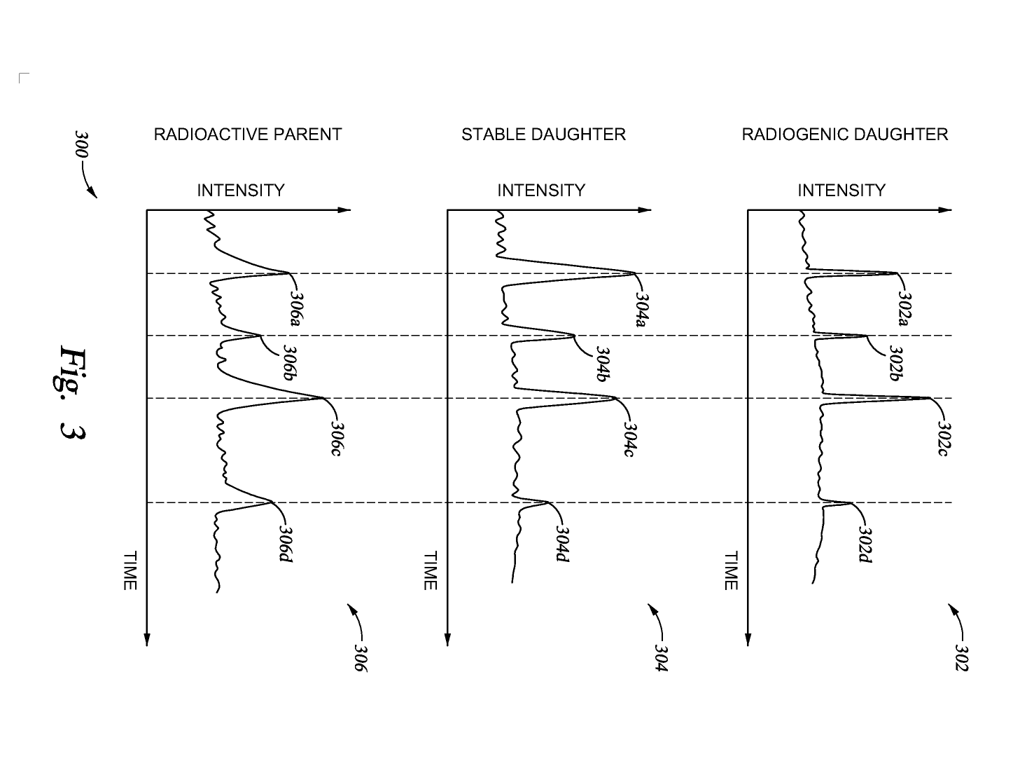

At blocks 208 and 210 the one or more species of interest may be supplied (block 208) to the mass spectrometer to generate (block 210) an intensity-versus-time data set (e.g., 110) for each of the two or more elemental masses. A non-limiting example having intensity-versus-time data sets corresponding to three elemental masses is provided in FIG. 3. In general, each of the intensity-versus-time data sets includes one or more intensity peaks and each of the intensity peaks corresponds to a species of interest. Additionally, the species of interest may be supplied to the mass spectrometer 108 using any appropriate mechanism, such as laser ablation.

At block 212 a set of intensity peaks is identified. The set includes members from each of at least two of the intensity-versus-time data sets. In general, each member corresponds to the same species of interest. In at least one embodiment of the present invention, intensity peaks corresponding to the same species of interest (e.g., 302a, 304a and 306a of FIG. 3) may have substantially identical elution times (i.e., the time that the elemental mass in question, as part of a given species of interest, is outputted during the separation process).

At block 214 the geologic age of the sample may be determined using ratios of the members of the set of intensity peaks. For example, FIG. 4 illustrates a geologic age determination in an embodiment where an intensity-versus-time data set is generated for three elemental masses (i.e., radiogenic daughter, stable daughter and radioactive parent). The ratio of a radiogenic daughter to a stable daughter may be plotted against the ratio of a radioactive parent to the stable daughter and the resulting curve/line 404 may be used to determine the geologic age of the sample. While plots corresponding to three elemental masses were used to construct the curve 404 of FIG. 4, it may be appreciated that a similar curve could be generated using only two elemental masses (e.g., radioactive parent and radiogenic daughter) as the elemental mass corresponding to stable daughter is a common divisor.

Block 216 represents the optional step of identifying a second set of intensity peaks having members from each of at least two of the intensity-versus-time data sets. In general the members of the second set (e.g., the set 302b, 304b, 306b; or the set 302b and 306b in the case where plot 304 was not generated) correspond to another one of the species of interest (i.e., a second species of interest).

At block 218 the determined geologic age of the sample may be optionally adjusted based on ratios of the members of the second set in a similar manner as the geologic age of the sample was determined at block 214.

At block 220 the determined (from block 214) and/or adjusted (from block 218) geologic age may be optionally used to calibrate a model such as a basin model.

Similarly, block 222 represents the optional step of using the determined (from block 214) and/or adjusted (from block 218) geologic age to determine a location of a petroleum reserve. In at least one embodiment, determining the location of the petroleum reserve may further include the use of an earth model running on a computer.

Block 224 represents an exit point out of the method 200.

Turning now to FIG. 3 a non-limiting example of intensity-versus-time data sets 300 that may be generated by a mass spectrometer (e.g., 108) in accordance with the method 200 of FIG. 2 is shown. In this particular example, the intensity of a radiogenic daughter is plotted against time at 302, the intensity of a stable daughter is plotted against time at 304, and the intensity of the radioactive parent is plotted against time at 306. It may be noted that the count of a given elemental mass as detected and recorded by, for example, a mass spectrometer is generally proportional to the concentration of the elemental mass and is typically referred to as the “intensity” of the elemental mass. Furthermore, it should be understood that while FIG. 3 shows the intensity-versus-time data set for each of three elemental masses, other embodiments may include intensity-versus-time data sets for only two elemental masses. As discussed previously in connection with block 214 of FIG. 2, proper selection of elemental masses may provide for determination of the geologic age of a sample with as few as two intensity-versus-time data sets. Once again, corresponding peaks (e.g., 302a, 304a and 306a) generally relate to the same species of interest.

FIG. 4 shows a non-limiting example of a plot 400 to determine the geologic age of a sample (e.g., 102) using ratios of a set of intensity peaks selected from data sets (e.g., 300). In this particular example, the ratio of a radiogenic daughter to a stable daughter is plotted against the ratio of a radioactive parent to the stable daughter to generate the isochron 404. Once again, since stable daughter is a common divisor an isochron having the same slope as curve 404 may be generated by plotting radiogenic daughter against radioactive parent (i.e., omitting stable daughter data).

Point 402 corresponds to time value zero (i.e., the time of the initial geologic event). The slope of the resulting curve 404 may be generally defined by the equation: slope=e^{λt-1} where λ equals a decay constant and t is time in millions of years. As will be generally appreciated by one skilled in the art having the benefit of this disclosure, the slope of the curve 404 corresponds to the age of the related sample.

In at least one embodiment, the radioactive parent and radiogenic daughter may be rhenium-187 and osmium-187, respectively. In such an embodiment the corresponding stable daughter mass would be osmium 188. Other radioactive parent/radiogenic daughter combinations may be U-235/Pb-207, U-238/Pb-206, and Th-232/Pb-208, for each of which Pb-204 is the common stable daughter mass; also Rb-87/Sr-87, for which Sr-86 is the stable daughter mass. However, any appropriate radioactive parent/radiogenic daughter combination may be used to satisfy the design criteria of a particular application.

In accordance with various embodiments of the present invention, aspects of the methods described herein may be implemented as software programs running on a computer processor (e.g., 112). Dedicated hardware implementations including, but not limited to, application specific integrated circuits, programmable logic arrays and other hardware devices can likewise be constructed to implement one or more of the method steps described herein. Furthermore, alternative software implementations including, but not limited to, distributed processing or component/object distributed processing, parallel processing, or virtual machine processing can also be constructed to implement one or more of the method steps described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only memories, random access memories, or other re-writable memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

The exemplary embodiments discussed above have been shown only by way of example. It should be understood that the invention is not intended to be limited to the particular embodiments disclosed herein. Indeed, the present invention includes all alternatives, modifications, and equivalents falling within the true spirit and scope of the appended claims.

What is claimed is:

1. A method for determining the geologic age of a sample of a naturally-occurring substance comprising:
separating the sample into one or more species of interest;
supplying the one or more species of interest to a mass spectrometer, the mass spectrometer configured for two or more elemental masses selected from the group consisting of radioactive-parent mass, radiogenic-daughter mass, and stable-daughter mass, wherein each of the selected two or more elemental masses are included in at least one of the one or more species of interest;
generating, via the mass spectrometer supplied with the one or more species of interest, an intensity-versus-time data set for each of the two or more elemental masses, wherein each of the intensity-versus-time data sets includes one or more intensity peaks, each of the intensity peaks corresponding to one of the species of interest;
identifying a set of intensity peaks having members from each of at least two of the intensity-versus-time data sets, the members corresponding to a single species of interest; and
determining the geologic age of the sample using ratios of the members of the set of intensity peaks.

2. The method of claim 1 wherein the mass spectrometer is an inductively-coupled plasma mass spectrometer.

3. The method of claim 2 wherein the mass spectrometer is a multi-collector inductively-coupled plasma mass spectrometer.

4. The method of claim 1 wherein the sample comprises at least one of petroleum and an aqueous fluid.

5. The method of claim 1 wherein a chromatographic column is used for separating the sample into one or more species of interest.

6. The method of claim 5 wherein the chromatographic column is a liquid-chromatography column.

7. The method of claim 6 wherein the liquid-chromatography column is a gel permeation chromatography column.

8. The method of claim 5 wherein the chromatographic column is a gas chromatography column.

9. The method of claim 5 wherein the chromatographic column separates the sample using at least one of polarity and molecular size.

10. The method of claim 1 wherein a chromatographic material is used for separating the sample into one or more species of interest.

11. The method of claim 10 wherein the chromatographic material is at least one of a paper based material and a gel based material.

12. The method of claim 1 further including using laser ablation to supply the one or more species of interest to the mass spectrometer.

13. The method of claim 1 further including the step of calibrating the mass spectrometer by adding an isotopic standard to the sample.

14. The method of claim 1 wherein each member of the set of intensity peaks has substantially the same elution time.

15. The method of claim 1 further including identifying a second set of intensity peaks having members from each of at least two of the intensity-versus-time data sets, the members of the second set corresponding to a second species of interest; and
adjusting the determined geologic age of the sample using ratios of the members of the second set to generate an adjusted geologic age of the sample.

16. The method of claim 15 further including using the adjusted geologic age to calibrate a basin model.

17. The method of claim 15 further including using the adjusted geologic age and an earth model running on a computer to determine a location of a petroleum reservoir.

18. The method of claim 1 further including using the determined geologic age to calibrate a basin model.

19. The method of claim 1 further including using the determined geologic age and an earth model running on a computer to determine a location of a petroleum reservoir.

20. A computer readable medium comprising non-transitory instructions for performing the following steps:
separating a sample into one or more species of interest;
supplying the one or more species of interest to a mass spectrometer, the mass spectrometer configured for two or more elemental masses selected from the group consisting of radioactive-parent mass, radiogenic-daughter mass, and stable-daughter mass, wherein each of the selected two or more elemental masses are included in at least one of the one or more species of interest;
generating, via the mass spectrometer supplied with the one or more species of interest, an intensity-versus-time data set for each of the two or more elemental masses, wherein each of the intensity-versus-time data sets includes one or more intensity peaks, each of the intensity peaks corresponding to one of the species of interest;
identifying a set of intensity peaks having members from each of at least two of the intensity-versus-time data sets, the members corresponding to a single species of the one or more species of interest; and
determining a geologic age of the sample using ratios of the members of the set of intensity peaks.

21. The computer readable medium of claim 20 further including non-transitory instructions for:
identifying a second set of intensity peaks having members from each of at least two of the intensity-versus-time data sets, the members of the second set corresponding to a second species of interest selected from the one or more species of interest; and
adjusting the determined geologic age of the sample using ratios of the members of the second set to generate an adjusted geologic age of the sample.

22. A system for determining the geologic age of a sample of a substance comprising:
a species generator configured to receive the sample and to generate one or more species of interest;
a mass spectrometer configured to receive the one or more species of interest and to generate an intensity-versus-time data set for each of two or more predetermined elemental masses, wherein each of the intensity-versus-time data sets includes one or more intensity peaks, each of the intensity peaks corresponding to one of the species of interest;
a processor configured to perform the following steps:
identifying a set of intensity peaks having members from each of at least two of the intensity-versus-time data sets, the members corresponding to a single species of the one or more species of interest; and
determining the geologic age of the sample using ratios of the members of the set of intensity peaks.

23. The system of claim 22 wherein the processor is further configured to perform the following steps:
identifying a second set of intensity peaks having members from each of at least two of the intensity-versus-time data sets, the members of the second set corresponding to a second species of interest selected from the one or more species of interest; and
adjusting the determined geologic age of the sample using ratios of the members of the second set to generate an adjusted geologic age of the sample.
